(19) United States
(12) Patent Application Publication
(10) Pub. No.: US 2018/0204110 A1
(43) Pub. Date: Jul. 19, 2018

(54) COMPRESSED NEURAL NETWORK SYSTEM USING SPARSE PARAMETERS AND DESIGN METHOD THEREOF

(71) Applicant: ELECTRONICS AND TELECOMMUNICATIONS RESEARCH INSTITUTE, Daejeon (KR)

(72) Inventors: Byung Jo KIM, Sejong (KR); Joo Hyun LEE, Daejeon (KR)

(21) Appl. No.: 15/867,601

(22) Filed: Jan. 10, 2018

(30) Foreign Application Priority Data
Jan. 16, 2017 (KR) 10-2017-0007176

(51) Int. Cl. G06N 3/04

(52) U.S. Cl. CPC G06N 3/04

(57) ABSTRACT

Provided is a design method of a compressed neural network system. The method includes generating a compressed neural network based on an original neural network model, analyzing a sparse weight among kernel parameters of the compressed neural network, calculating a maximum possible calculation throughput on a target hardware platform according to a sparse property of the sparse weight, calculating a calculation throughput with respect to access to an external memory on the target hardware platform according to the sparse property, and determining a design parameter on the target hardware platform by referring the maximum possible calculation throughput and the calculation throughput with respect to access.

### CROSS-REFERENCE TO RELATED APPLICATIONS

This U.S. non-provisional patent application claims priority under 35 U.S.C. § 119 of Korean Patent Application No. 10-2017-0007176, filed on Jan. 16, 2017, the entire contents of which are hereby incorporated by reference.

### BACKGROUND

The present disclosure relates to a neural network system, and more particularly, to a compressed neural network system using sparse parameters and a design method thereof.

Recently, Convolutional Neural Network (CNN), which is one of Deep Neural Network techniques, is actively studied as a technology for image recognition. The neural network structure shows excellent performance in various object recognition fields such as object recognition and handwriting recognition. In particular, the CNN provides very effective performance for object recognition.

A CNN Model may be implemented in hardware on a Graphic Processing Unit (GPU) or Field Programmable Gate Array (FPGA) platform. When implementing the CNN model in hardware, it is important to select the logic resources and memory bandwidth of the platform in order to achieve the best performance. However, CNN models emerged after Alexnet include a relatively large number of layers. In order to implement a CNN model as mobile hardware, parameter reduction should precede. In the case of convolutional neural networks with many layers, due to the large size of the parameters, it is difficult to implement them with limited Digital Signal Processors (DSPs) or Block RAM (BRAM) provided on the FPGA.

Therefore, there is an urgent need for a technique for implementing such a CNN model as mobile hardware.

### SUMMARY

The present disclosure provides a method of determining a design parameter for implementing a CNN model in mobile hardware. The present disclosure also provides a method for determining a design parameter of a CNN system in consideration of the sparse property of a sparse weight generated according to neural network compression techniques. The present disclosure also provides a design method for determining a calculation capability, a memory resource, and a memory bandwidth of an FPGA or the like by referring to the sparse property of a sparse weight when a compressed neural network having a sparse weight parameter is implemented as a hardware platform.

The present disclosure also provides a method of determining a design factor in consideration of the sparse properties of the sparse weights of the number of calculations of the entire layer, the number of calculation cycles, and the calculation throughput to memory access.

An embodiment of the inventive concept provides a design method of a compressed neural network system. The method includes: generating a compressed neural network based on an original neural network model; analyzing a sparse weight among kernel parameters of the compressed neural network; calculating a maximum possible calculation throughput on a target hardware platform according to a sparse property of the sparse weight; calculating a calculation throughput with respect to access to an external memory on the target hardware platform according to the sparse property; and determining a design parameter on the target hardware platform by referring the maximum possible calculation throughput and the calculation throughput with respect to access.

In an embodiment of the inventive concept, a compressed neural network system includes: an input buffer configured to receive an input feature from an external memory and buffer the received input feature; a weight kernel buffer configured to receive a kernel weight from the external memory; a multiplication-accumulation (MAC) calculation unit configured to perform a convolution operation by using fragments of the input feature provided from the input buffer and a sparse weight provided from the weight kernel buffer; and an output buffer configured to store a result of the convolution operation in an output feature unit and deliver the stored result to the external memory, wherein sizes of the input buffer, the output buffer, the fragments of the input feature, and a calculation throughput and a calculation cycle of the MAC calculation unit are determined according to a sparse property of the sparse weight.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a graphical diagram of CNN layers according to an embodiment of the inventive concept;

FIG. 2 is a block diagram briefly illustrating a CNN system of the inventive concept implemented in hardware;

FIG. 3 is a simplified view of input or output features and a kernel during a convolution operation in a compressed neural network model according to an embodiment of the inventive concept;

FIG. 4 is a view exemplarily illustrating a sparse weight kernel of the inventive concept;

FIG. 5 is a flowchart illustrating a method for determining hardware design parameters using a sparse weight of a compressed neural network of the inventive concept;

FIG. 6 is a flowchart illustrating a method for calculating a maximum calculation throughput and an operation calculation throughput with respect to memory access in a single layer under the target hardware condition of FIG. 5;

FIG. 7 is an algorithm illustrating one example of a convolution operation loop performed in consideration of a sparse property of a sparse weight; and

FIG. 8 is an algorithm illustrating another example of a convolution operation loop performed in consideration of a sparse property of a sparse weight.

### DETAILED DESCRIPTION

In general, a convolution operation is a calculation for detecting a correlation between two functions. The term “Convolutional Neural Network (CNN)” refers to a process or system for performing a convolution operation with a kernel indicating a specific feature and repeating a result of the calculation to determine a pattern of an image.

In the following, embodiments of the inventive concept will be described in detail so that those skilled in the art easily carry out the inventive concept.

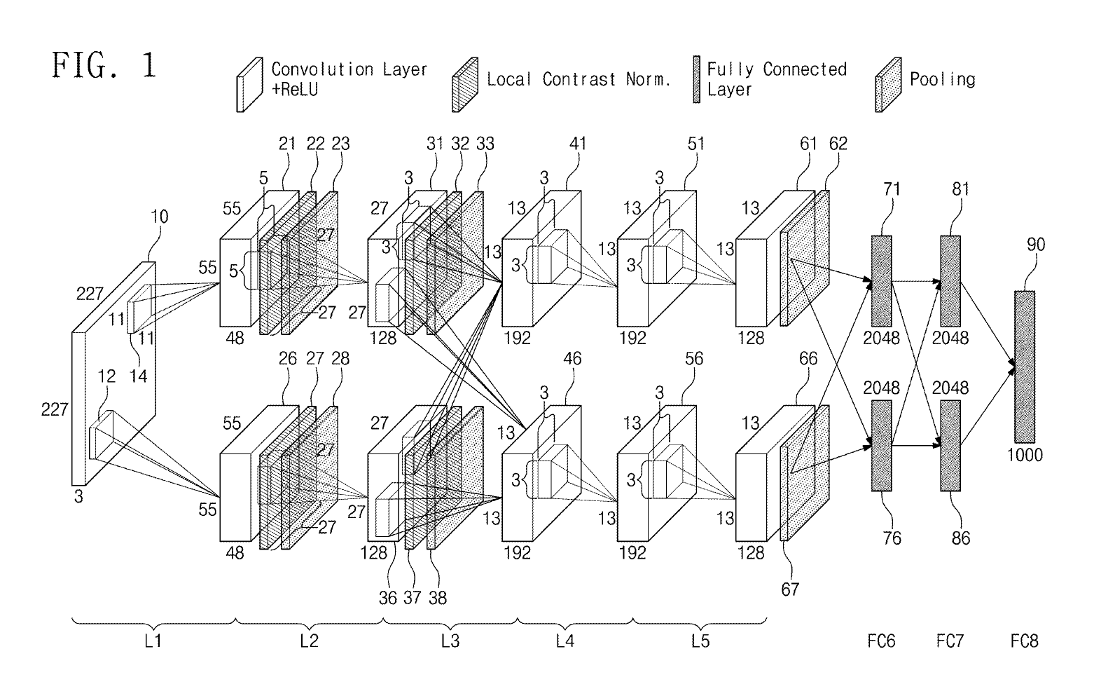

FIG. 1 is a graphical diagram of CNN layers according to an embodiment of the inventive concept. Referring to FIG. 1, when applying the compressed neural network of the inventive concept to Alexnet, the sizes of input and output features and the sizes of kernels (or weight filters) are illustratively shown.

An input feature 10 may include three input feature maps of a size (227×227) representing the horizontal and vertical sizes. The three input feature maps may be the R/G/B components of the input image. When a convolution operation using kernels 12 and 14 is performed, the input feature 10 may be divided into two neural network sets of the upper and the lower. The processes of convolution operation, activation, sub-sampling, etc. of each of the upper and lower neural network sets are substantially the same. For example, in the upper set, a convolution operation with the kernel 14 to extract features not related to color may be performed, and in the lower set, a convolution operation with the kernel 12 to extract features related to color may be performed.

The feature maps 21 and 26 will be generated by the execution of a convolution layer L1 using the input features 10 and the kernels 12 and 14. The size of each of the feature maps 21 and 26 is output as 55×55×48.

The feature maps 21 and 26 are processed using a convolution layer L2, activation filters 22 and 27, and pulling filters 23 and 28 to be outputted as feature maps 31 and 36 of 27×27×128 size, respectively. The feature maps 31 and 36 are processed using a convolution layer L3, activation filters 32 and 37, and pulling filters 33 and 38 to be outputted as feature maps 41 and 46 of 13×13×192 size, respectively. The feature maps 41 and 46 are outputted as feature maps 51 and 56 of 13×13×192 size by the execution of a convolution layer L4. The feature maps 51 and 56 are outputted as feature maps 61 and 66 of 13×13×128 size by the execution of a convolution layer L5. The feature maps 61 and 66 are outputted as fully connected layers 71 and 76 of 2048 size by the execution and pooling (e.g., Max pooling) of the convolution layer L5. Then, the fully connected layers 71 and 76 may be represented by the connection to fully connected layers 81 and 86 and may be finally outputted as a fully connected layer.

The neural network includes an input layer, a hidden layer, and an output layer. The input layer receives input to perform learning and delivers it to the hidden layer, and the output layer generates the output of the neural network from the hidden layer. The hidden layer may change the learning data delivered through the input layer to a value that is easy to predict. Nodes included in the input layer and the hidden layer may be connected to each other through weights, and nodes included in the hidden layer and the output layer may be connected to each other through weights.

In neural networks, the calculation throughput between the input and hidden layers may be determined by the number of input and output features. And, as the depth of the layer becomes deeper, the calculation throughput according to the size of the weight and the input/output layer is drastically increased. Thus, attempts are made to reduce the sizes of these parameters in order to implement the neural network in hardware. For example, parameter drop-out techniques, weight sharing techniques, quantization techniques, etc. may be used to reduce the sizes of parameters. The parameter drop-out technique is a method of removing low weighted parameters among the parameters in the neural network. The weight sharing technique is a technique for reducing the number of parameters to be processed by sharing parameters having similar weights. And, the quantization technique is used to reduce the number of parameters by quantizing the weight and the size of the bits of the input/output layer and the hidden layer.

In the above, feature maps, kernels, and connection parameters for each layer of the CNN are briefly described. In the case of Alexnet, it is known to consist of about 650,000 neurons, about 60 million parameters, and 630 million connections. A compression model is required to implement such a large-scale neural network in hardware. In the inventive concept, a hardware design parameter may be generated considering a sparse weight among kernel parameters in a compressed neural network.

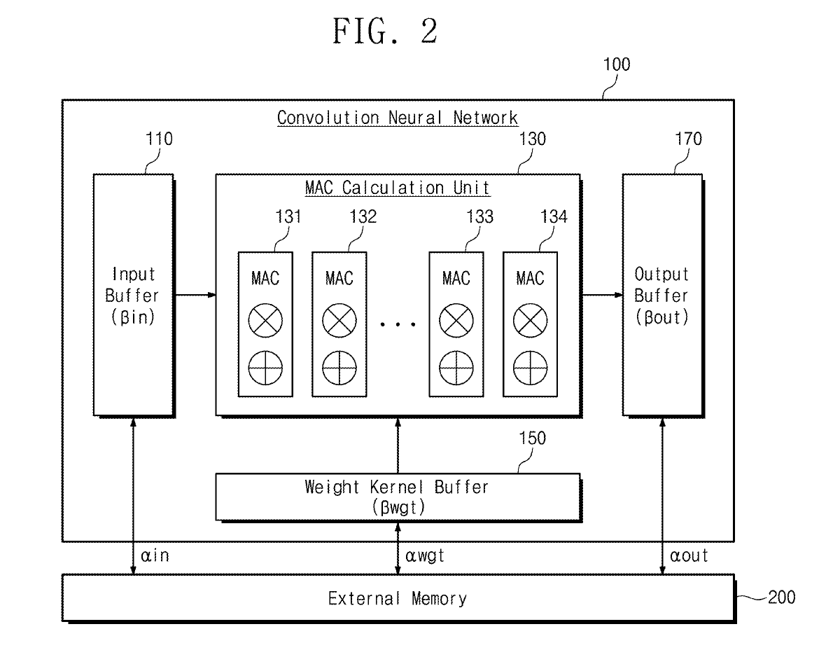

FIG. 2 is a block diagram briefly illustrating a CNN system of the inventive concept implemented in hardware. Referring to FIG. 2, the neural network system according to an embodiment of the inventive concept is shown as essential components for implementing hardware such as an FPGA or a GPU. The CNN system 100 of the inventive concept includes an input buffer 110, a MAC calculation unit 130, a weight kernel buffer 150, and an output buffer 170. And, the input buffer 110, the weight kernel buffer 150, and the output buffer 170 of the CNN system 100 are configured to access the external memory 200.

The input buffer 110 is loaded with the data values of the input features. The size of the input buffer 110 may vary depending on the size of a kernel for the convolution operation. For example, when the size of the kernel is K×K, the input buffer 110 should be loaded with an input data of a size sufficient to sequentially perform a convolution operation with the kernel by the MAC calculation unit 130. The input buffer 110 may be defined by a buffer size βin for storing an input feature. And, the input buffer 110 has factors of the external memory 200 and the number of accesses αin to receive the input features.

The MAC calculation unit 130 may perform a convolution operation using the input buffer 110, the weight kernel buffer 150, and the output buffer 170. The MAC calculation unit 130 processes multiplication and accumulation with the kernel for the input feature, for example. The MAC calculation unit 130 may include a plurality of MAC cores 131, 132, . . . , 134 for processing a plurality of convolution operations in parallel. The MAC calculation unit 130 may process the convolution operation with the kernel provided from the weight kernel buffer 150 and the input feature fragment stored in the input buffer 110 in parallel. At this time, the weight kernel of the inventive concept includes a sparse weight.

The sparse weight is an element of a compressed neural network and represents a compressed connection or a compressed kernel rather than representing connections of all neurons. For example, in a two-dimensional K×K size kernel, some of the weights are compressed to have a value of ‘0’. At this time, a weight having no ‘0’ is referred to as a sparse weight. When a kernel with such a sparse weight is used, a calculation amount may be reduced in the CNN. That is, the overall calculation throughput is reduced according to the sparse property of the weight kernel filter. For example, if ‘0’ is 90% of the total weights in the two-dimensional K×K size weight kernel, the sparse property may be 90%. Thus, if the sparse property uses a 90% weight kernel, the actual calculation amount is reduced to 10% with respect to the calculation amount using a non-sparse weight kernel.

The weighting kernel buffer 150 provides parameters necessary for a convolution operation, bias addition, activation (ReLU), and pooling performed in the MAC calculation unit 130. And, the parameters learned in the learning operation may be stored in the weight parameter buffer 150. The weight kernel buffer 150 may be defined by a buffer size βwgt for storing a sparse weight kernel. And, the weight kernel buffer 150 may have a factor of an external memory 200 and an access number αwgt for receiving a sparse weight kernel.

The output buffer 170 is loaded with the result value of the convolution operation or the pulling performed by the MAC calculation unit 130. The result value loaded into the output buffer 170 is updated according to the execution result of each convolution loop by the plurality of kernels. The output buffer 170 may be defined by a buffer size βout for storing an output feature of the MAC calculation unit 130. And, the output buffer 170 may have a factor of an access number αout for providing an output feature to the external memory 200.

The CNN model having the above-described configuration may be implemented in hardware such as an FPGA or a GPU. At this time, in consideration of the resource, operation time, power consumption, etc of a hardware platform, the sizes βin and βout of the input and output buffers, the size βwgt of a weight kernel buffer, the number of parallel processing MAC cores, and the numbers αin, αwgt, and αout of memory accesses should be determined. For a general neural network design, the design parameters are determined on the assumption that the weights of the kernel are filled with non-zero values. That is, a roof top model is used to determine general neural network design parameters. However, when the neural network model is implemented on mobile hardware and a limited FPGA, it is necessary to use a compressed neural network which reduces a neural network size. At this time, in a compressed neural network, the kernel should be configured to have a sparse weight value. Therefore, although described later, a new design parameter determination method considering the sparse property of a compressed neural network is needed.

In the above, the configuration of the CNN system 100 of the inventive concept has been exemplarily described. In the case of using the above-described sparse weight, the sizes βin, βout, and βwgt of input/output and weight kernel buffers and the numbers αin, αwgt, and αout of external memory accesses will be determined according to the sparse property.

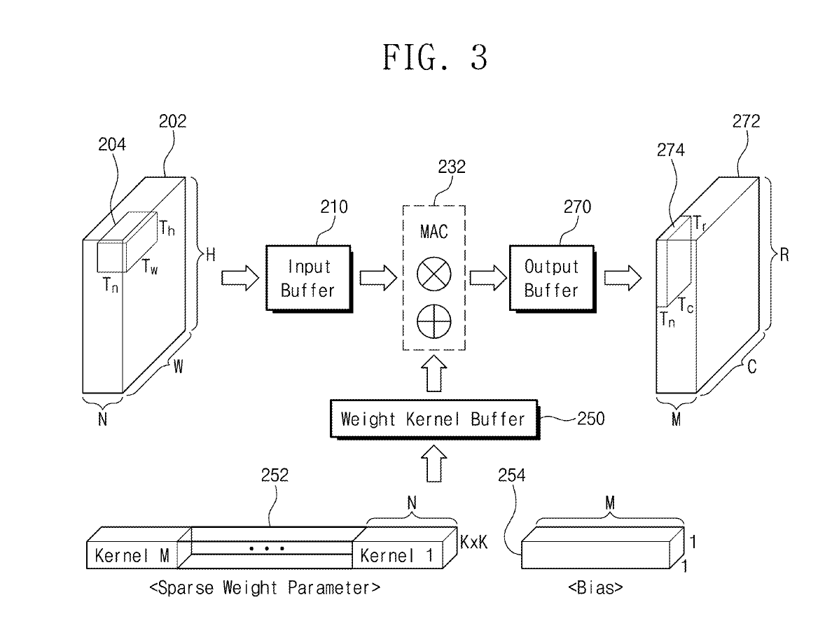

FIG. 3 is a simplified view of input or output features and a kernel during a convolution operation in a compressed neural network model according to an embodiment of the inventive concept. Referring to FIG. 3, one MAC core 232 processes data provided from the input buffer 210 and the weight kernel buffer 250, and delivers the processed data to the output buffer 270.

The input feature 202 will be provided to the input buffer 210 from the external memory 200. The input feature 202 of W×H×N size may be delivered to the input buffer 210 in fragment units processed by one MAC core 232. For example, an input feature fragment 204 that is delivered to one MAC core 232 for convolution processing may be provided in a Tw×Th×T size. The input feature fragment 204 of Tw×Th×Tn size provided in the input buffer 210 and the kernel of K×K size provided in the weight kernel buffer 250 are processed by the MAC core 232. This convolution operation may be executed in parallel by the plurality of MAC cores 131, 132, . . . , 134 shown in FIG. 2.

One of the plurality of kernels 252 and the input feature fragment 204 are processed by a convolution operation. That is, overlapping data of the K×K size kernel and the input feature fragment 204 are multiplied with each other (Multiplexing). Then, the values of the multiplied data are accumulated to generate a single feature value. Such an input feature fragment 204 is selected sequentially for the input feature 202 and will be processed using a convolution operation with each of the plurality of kernels 252. Then, M output feature maps 272 of R×C size corresponding to the number of kernels are generated. The output feature 272 may be outputted to the output buffer 270 in units of the output feature fragment 274 and may be exchanged with the external memory 200. After the convolution operation with the MAC core 232, a bias 254 may be added to each feature value. The bias 254 may be added to the output feature as an M size of the number of channels.

When the above-described configuration is implemented in an FPGA platform, the size of the input buffer 210, the weight kernel buffer 250, the output buffer 270, and the size of the input feature fragment 204 or the output feature fragment 274 should be determined with values that provide maximum performance. By analyzing the sparse property of a compressed neural network, the maximum possible calculation throughput and the operation calculation throughput with respect to memory access may be calculated. Then, when these calculation results are used, the maximum operating point for maximum performance may be extracted while making the best use of FPGA resources. The size of the input buffer 210, the weight kernel buffer 250, the output buffer 270, and the size of the input feature fragment 204 or the output feature fragment 274, which correspond to this maximum operating point, may be determined.

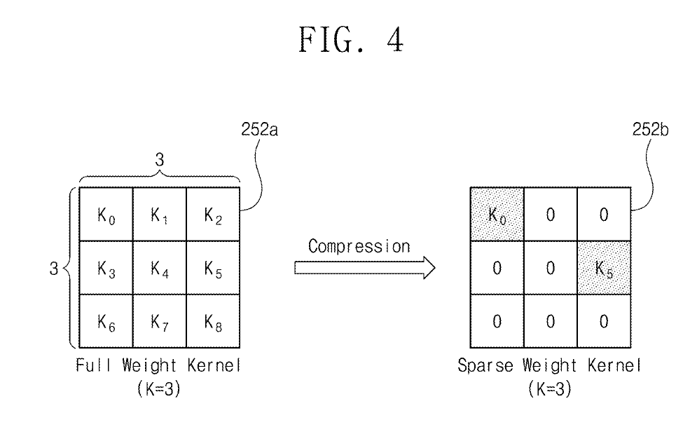

FIG. 4 is a view exemplarily illustrating a sparse weight kernel of the inventive concept. Referring to FIG. 4, a full weight kernel 252a in an original neural network model is transformed into a sparse weight kernel 252b of a compressed neural network.

The full weight kernel 252a of K×K size (assuming K=3) may be represented by a matrix having nine filter values K0 to K8. As a technique for generating a compressed neural network, parameter drop-out, weight sharing, quantization, and the like may be used. The parameter drop-out technique is a technique that omits some neurons from an input feature or a hidden layer. The weight sharing technique is a technique in which the same or similar parameters are mapped to parameters having a single representative value for each layer in the neural network and are shared. And, the quantization technique is a method of quantizing the data size of the weight, or the input/output layer and the hidden layer. However, it will be understood that the method of generating a compressed neural network is not limited to the techniques described above.

The kernel of a compressed neural network is switched to a sparse weight kernel 252b with a filter value of ‘0’. That is, the filter values K₁, K₂, K₃, K₄, K₆, K₇, and K₈ of the full weight kernel 252a are converted into ‘0’ by compression and the remaining filter values K₀ and K₅ are converted into sparse weights. The kernel characteristics in a compressed neural network depend largely on the locations and values of these sparse weights K₀ and K₅. When substantially performing the convolution operation of the input feature fragment and the kernel in the MAC core 232, since the filter values K₁, K₂, K₃, K₄, K₆, K₇, and K₈ are ‘0’, the multiplication calculation and the addition calculation for them may be omitted. Thus, only multiplication calculations and addition calculations on sparse weights will be performed. Therefore, in the convolution operation using only the sparse weight of the sparse weight kernel 252b, the amount of computation is greatly reduced. In addition, since only the sparse weight, not the full weight, is exchanged with the external memory 200, the number of memory accesses will also decrease.

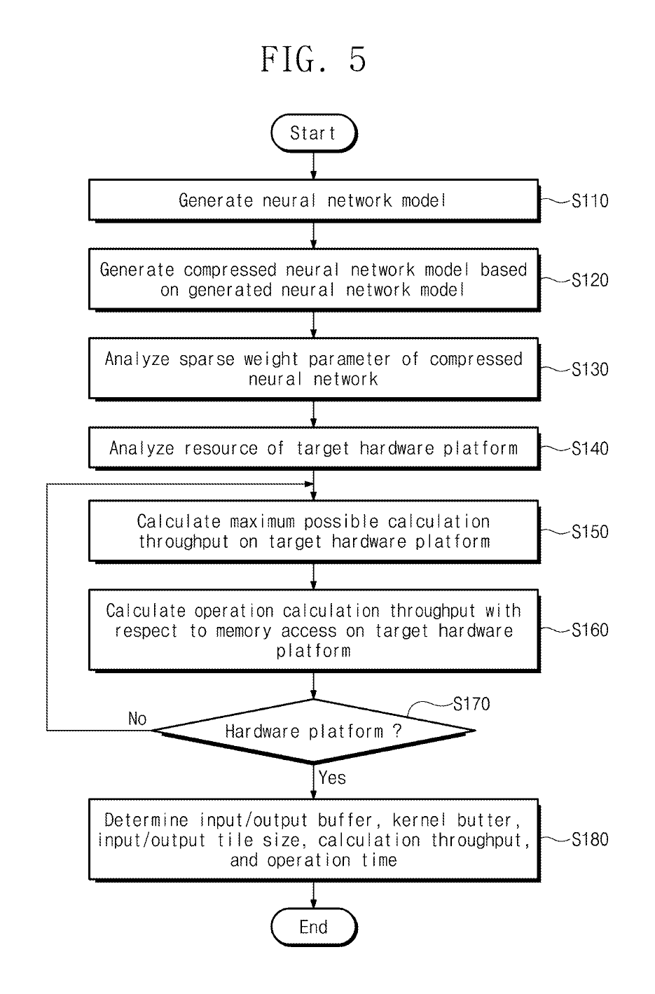

FIG. 5 is a flowchart illustrating a method for determining hardware design parameters using a sparse weight of a compressed neural network of the inventive concept. Referring to FIG. 5, a sparse weight of a compressed neural network may be analyzed to calculate design parameters for a hardware implementation.

In operation S110, a neural network model is generated. A framework for defining and simulating various neural network structures using a text editor (e.g., Caffe) may be used for the generation of the neural network model. Through the framework, the number of iterations, Snapshot, initial parameter definition, learning rate related parameters, etc. required in the learning process may be configured and executed as a Solver file. A neural network model may be generated according to the network structure defined in the framework.

In operation S120, a compressed neural network will be generated from the generated neural network model. In order to generate a compressed neural network, at least one of techniques such as parameter drop-out, weight sharing, and quantization for the generated neural network model may be applied. The full weighted kernels of the generated compressed neural network are changed to sparse weighted kernels with a value of ‘0’.

In operation S130, a sparse property analysis is performed on the sparse weight in the compressed neural network. The ratio between the weight of ‘zero(0)’ and the weight of ‘non-zero(0)’ among the kernel weights of the compressed neural network may be calculated. That is, the sparse property of the sparse weight may be calculated. The sparse property may be set to 90% when the number of weights of ‘zero(0)’ among all kernel weights is 90% of the number of sparse weights of ‘non-zero(0)’. In this case, the actual convolution operation amount of the compressed neural network model will be reduced by 90% compared to the original neural network model.

In operation S140, the resource information of the target hardware platform is provided and analyzed. For example, if the target hardware platform is an FPGA, resources such as a digital signal processor (DSP) or block RAM (BRAM) configurable on the FPGA may be analyzed and extracted.

In operation S150, the maximum possible calculation throughput on the target hardware platform is calculated. If the target hardware platform is an FPGA, the maximum calculation throughput (i.e., computation roof) that is possible using resources such as a digital signal processor (DSP) or block RAM (BRAM) configurable on the FPGA is calculated. The maximum calculation throughput may be calculated from Equation 1 below.

$$Computation Roof = \frac{Number of operations}{Number of execution cycles} \qquad [ Equation 1 ]$$

The number of calculations, which is the numerator in Equation 1, may be expressed by Equation 2 below.

$$2 \times R \times C \times {\sum }_{m = 1}^{⌈ \frac{M}{{T}_{m}} ⌉} {\sum }_{n = 1}^{⌈ \frac{N}{{T}_{n}} ⌉} {[ {\sum }_{k = 1}^{{T}_{m}} {\sum }_{i = 1}^{{T}_{n}} kernel\_nnz \_num {\_total}_{ki} ]}_{mn} \qquad [ Equation 2 ]$$

The factor kernel_nnz_num_totalₖᵢ in Equation 2 represents the number of sparse weights that are not ‘0’ in a two-dimensional K×K size kernel. R and C respectively denote the size of the output feature, M denotes the number of kernels or the number of channels of the output feature, and N denotes the number of input features.

The number of execution cycles, which is the denominator in Equation 1, may be expressed by Equation 3 below.

$$[ Equation 3 ]$$

$$\frac{R}{{T}_{r}} \times \frac{C}{{T}_{c}} \times ( {\sum }_{m = 1}^{⌈ \frac{M}{{T}_{m}} ⌉} {\sum }_{n = 1}^{⌈ \frac{N}{{T}_{n}} ⌉} {[ {T}_{r} \times {T}_{c} \times {max}_{1 \leq k \leq {T}_{m} , 1 \leq i \leq {T}_{n}} [ kernel\_nnz {\_num}_{ki} ] + P ]}_{mn} )$$

Assuming that the number of MAC cores configuring the neural network in the FPGA or the target platform is Tm×Tn, the number of execution cycles in Equation 3 represents the number of cycles when the MAC calculation is performed by dividing the sparse weight kernel by the Tm×Tn fragment size. Equation 3 may vary depending on the fragment size of the sparse weight kernel and the configuration manner of an iterative loop of the convolution operation loop.

In Equation 3, the maximum value of the execution cycle is determined according to the sparse property maximum value of the sparse weight kernel. For example, if the maximum sparse property of the sparse weight kernel of Tm×Tn size is 90%, the number of calculation cycles will be determined by the slowest cycle in the parallel processing MAC calculation. That is, the number of calculation cycles is reduced to 10% with respect to the calculation cycle in a neural network calculation using a full weight kernel. That is, this means that the operation Speed may be improved about 10 times according to the hardware implementation.

If the maximum calculation throughput (i.e., computation roof) is expressed again using Equation 1, Equation 2, and Equation 3, it is expressed by Equation 4.

$$[ Equation 4 ]$$

$$\frac{2 \times R \times C \times {\sum }_{m = 1}^{⌈ \frac{M}{{T}_{m}} ⌉} {\sum }_{n = 1}^{⌈ \frac{N}{{T}_{n}} ⌉} {[ {\sum }_{k = 1}^{{T}_{m}} {\sum }_{i = 1}^{{T}_{n}} kernel\_nnz \_num {\_total}_{ki} ]}_{mn}}{\begin{matrix}\frac{R}{{T}_{r}} \times \frac{C}{{T}_{c}} \times \\ ( {\sum }_{m = 1}^{⌈ \frac{M}{{T}_{m}} ⌉} {\sum }_{n = 1}^{⌈ \frac{N}{{T}_{n}} ⌉} {[ {T}_{r} \times {T}_{c} \times {max}_{1 \leq k \leq {T}_{m} , 1 \leq i \leq {T}_{n}} [ kernel\_nnz {\_num}_{ki} ] + P ]}_{mn} )\end{matrix}}$$

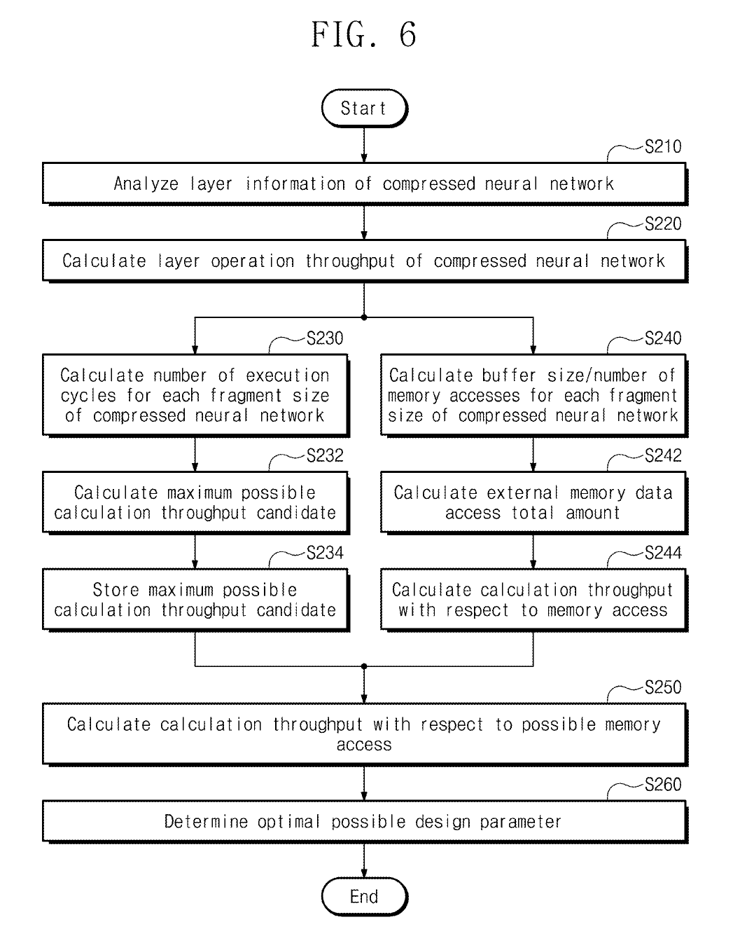

Based on the above equations, the maximum calculation throughput (i.e., computation roof) operable in the FPGA will be calculated considering the sparse weights. And, the maximum possible calculation amount for each fragment size in one layer of the compressed neural network described later with reference to FIG. 6 may be calculated. Then, based on these values, the possible design parameters for each of Tm, Tn, Tr, and Tc fragment sizes in one layer of the compressed neural network may be stored as candidates.

In operation S160, the number of operation calculations with respect to memory access in the target hardware platform is calculated. The number of operation calculations CCRatio with respect to memory access may be expressed by Equation 5 below.

$${CC}_{Ratio} = \frac{Number of operations}{Access number of external memory} \qquad [ Equation 5 ]$$

The number of calculations, which is the numerator in Equation 5, may be equal to Equation 2. Then, the access number of the external memory, which is the denominator in Equation 5, may be calculated through Equation 6 below.

αᵢₙ×βᵢₙ+α_{wgt}×β_{wgt}+αₒᵤₜ×βₒᵤₜ [Equation 6]

In operation S170, it is determined whether the determined maximum calculation throughput and the operation calculation throughput with respect to memory access correspond to the maximum operating point corresponding to the resource of the target hardware platform. If the maximum calculation throughput and the operation calculation throughput with respect to memory access are the maximum operating point corresponding to the resource of the target hardware platform, the procedure moves to operation S180. On the other hand, if the maximum calculation throughput and the operation calculation throughput with respect to memory access are not the maximum operating point corresponding to the resource of the target hardware platform, the procedure returns to operation S150.

In operation S180, the input/output buffer, the kernel buffer, the size of the input/output tile, the calculation throughput, and the operation time of the target hardware platform are determined using the maximum calculation throughput and the operation calculation throughput with respect to memory access.

The method for determining the design parameters of the target hardware platform is briefly described in consideration of the sparse weight of the compressed neural network of the inventive concept.

FIG. 6 is a flowchart illustrating a method for calculating a maximum calculation throughput and an operation calculation throughput with respect to memory access in a single layer under the target hardware condition of FIG. 5. Referring to FIG. 6, the maximum calculation throughput possible for each fragment size of an input feature or an output feature in one layer is calculated and stored as a candidate for the maximum possible calculation throughput.

In operation S210, information on a specific layer of the generated compressed neural network is analyzed. For example, the sparse property of a sparse weight kernel in one layer may be analyzed. For example, the ratio of ‘0’ among the filter values of the sparse weight kernel may be calculated.

In operation S220, the calculation throughput is calculated using information of one layer of the compressed neural network. For example, the maximum calculation throughput according to the sparse property of a sparse weight in one layer may be calculated.

In operation S230, the number of execution cycles for each fragment size of the compressed neural network may be calculated. That is, the number of execution cycles required for processing each of the sizes Tn, Th, and Tw of the input feature fragment and the sizes Tm, Tr, and Tc of the output feature fragment is calculated. In order to calculate the number of execution cycles, the resource information of the target hardware platform and the method of a calculation execution loop may be selected and provided.

That is, by referring to the number of execution cycles required for processing each of the sizes Tn, Th, and Tw of the input feature fragment and the sizes Tm, Tr, and Tc of the output feature fragment, the maximum possible throughput candidates in one layer are calculated.

In operation S234, the maximum possible calculation throughput candidates calculated in operation S232 are stored in a specific memory.

In operation S240, the buffer size and the memory access number for each fragment size of the compressed neural network may be calculated. That is, the sizes of the input buffer 210, the weight kernel buffer 250, and the output buffer 270 required for processing each of the sizes Tn, Th, and Tw of the input feature fragment and the sizes Tm, Tr, and Tc of the output feature fragment may be calculated. And, the number of accesses to the external memory 200 of the input buffer 210, the weight kernel buffer 250, and the output buffer 270 will be calculated. In order to calculate the buffer size and the memory access number for each fragment size of the compressed neural network, the resource information of the target hardware platform and the method of a calculation execution loop may be selected and provided.

In operation S242, the total amount of access to the external memory required for processing each of the sizes Tn, Th, and Tw of the input feature fragment and the sizes Tm, Tr, and Tc of the output feature fragment is calculated.

In operation S244, the calculation throughput with respect to memory access is calculated based on the total amount of access calculated in operation S242. Here, operations S230 to S234 and operations S240 to S244 may be respectively performed in parallel or sequentially.

In operation S250, the number of possible memory accesses among the values calculated through operations S240 to S244 is determined. And, a calculation throughput corresponding to the determined number of memory accesses may be selected using the values determined in operations S230 to S234.

In operation S260, possible optimum design parameters are determined. That is, the maximum values (e.g., the maximum possible calculation throughput and the operation calculation throughput with respect to memory access) that satisfy the resources in the hardware platform may be selected based on the calculation throughput in the number of realizable memory accesses selected in operation S250. And, the sizes of the input feature fragment and the output feature fragment corresponding to the selected maximum value will be the optimum fragment size of the neural network system included in Tm×Tn parallel MAC cores. In addition, at this time, the total operation calculation throughput and the number of calculation cycles of the corresponding layer may be calculated.

Through this procedure, the design parameters of the optimal hardware platform realizable in the target platform may be determined.

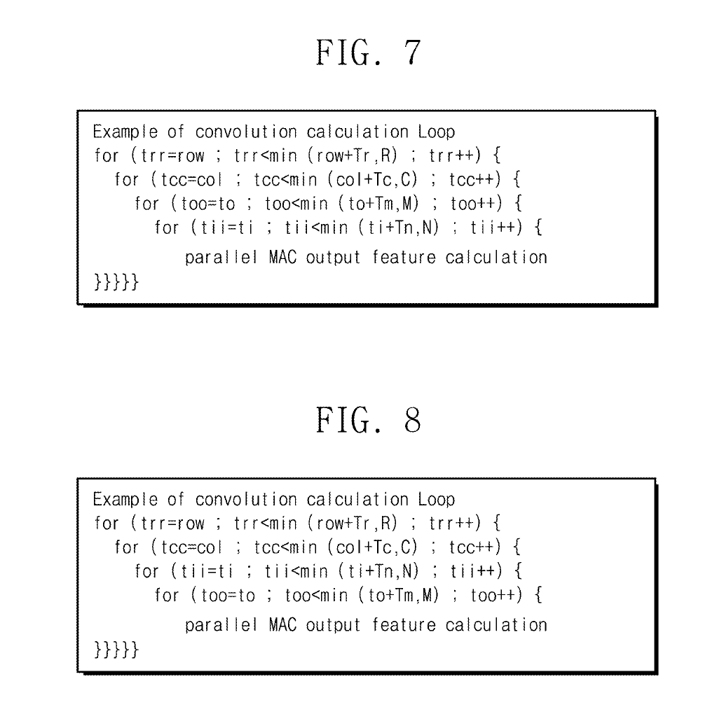

FIG. 7 is an algorithm illustrating one example of a convolution operation loop performed in consideration of a sparse property of a sparse weight. Referring to FIG. 7, in the convolution operation loop, the convolution operation is performed by Tm×Tn parallel MAC cores.

The progression of the convolution loop includes a progression of the convolution operation to generate an output feature by the parallel MAC cores and a selection loop of input and output features for performing these calculations. The convolution operation to generate output features by parallel MAC cores is performed at the innermost of the algorithm loop. And, in the selection of feature fragments to perform the convolution operation, there is a loop (N-loop) that selects the fragments of the input feature outside the convolution operation. The loop (M-loop) that selects the fragments of the output feature is located outside the loop (N-loop) that selects the fragments of the input feature. Then, loops (C-loop, R-loop) that select the rows and columns of the output feature are then placed outside the loop (M-loop) that sequentially selects the output feature fragments.

The above-described buffer size for the progression of the convolution loop may be calculated by Equation 7 below.

$$[ Equation 7 ]$$

$$\begin{matrix}{β}_{in} = {T}_{n} \times ( {ST}_{r} + K - S ) \times ( {ST}_{c} + K - S ) \times DATA SIZE ( bytes ) \\ {β}_{wgt} = {\sum }_{k = 1}^{{T}_{m}} {\sum }_{i = 1}^{{T}_{n}} kernel\_nnz \_num {\_total}_{ki} \times DATA SIZE ( bytes ) \\ {β}_{out} = {T}_{m} \times {T}_{r} \times {T}_{c} \times DATA SIZE ( bytes ) \\ {β}_{in} + {β}_{wgt} + {β}_{out} \leq TARGET PLATFORMBRAMSIZE\end{matrix}$$

Here, S represents the stride of the pooling filter. Then, the number of accesses to the external memory may be calculated by Equation 8 below.

$${α}_{in} = {α}_{wgt} = \frac{M}{{T}_{m}} \times \frac{N}{{T}_{n}} \times \frac{R}{{T}_{r}} \times \frac{C}{{T}_{c}} \\ {α}_{out} = \frac{M}{{T}_{m}} \times \frac{R}{{T}_{r}} \times \frac{C}{{T}_{c}} \qquad [ Equation 8 ]$$

Through the above determined factors, the calculation throughput with respect to memory access may be expressed by Equation 9 below.

$$[ Equation 9 ]$$

$$\frac{2 \times R \times C \times {\sum }_{m = 1}^{⌈ \frac{M}{{T}_{m}} ⌉} {\sum }_{n = 1}^{⌈ \frac{N}{{T}_{n}} ⌉} {[ {\sum }_{k = 1}^{{T}_{m}} {\sum }_{i = 1}^{{T}_{n}} kernel\_nnz \_num {\_total}_{ki} ]}_{mn}}{{α}_{in} \times {β}_{in} + {α}_{wgt} \times {β}_{wgt} + {α}_{out} \times {β}_{out}}$$

As in the calculation of the maximum possible calculation amount (i.e., computation roof), the operation calculation throughput with respect to memory access for each fragment size of the input or output feature may be calculated in a single layer of a compressed neural network. Then, by using the result, the maximum possible value may be generated and stored as a design candidate. Through this, among the maximum value possible candidates calculated in Equation 4, it is possible to find any one whose operation calculation throughput with respect to memory access calculated in Equation 9 is the maximum.

Lastly, the fragment size of the input and output features with the two maximum values (e.g., the maximum possible calculation throughput and the operation calculation throughput with respect to memory access) that satisfy the target hardware platform resource is finally to be the optimal fragment size in a neural network operation that operates the Tm×Tn parallel MACs. Then, the total operation calculation throughput and the number of calculation cycles of the corresponding layer calculated at that time may be extracted. Through this, the design value of the optimal neural network convolution operation possible in the target platform may be finally determined.

FIG. 8 is an algorithm illustrating another example of a convolution operation loop performed in consideration of a sparse property of a sparse weight. Referring to FIG. 8, in the convolution operation loop, the convolution operation is performed by Tm×Tn parallel MAC cores.

The progression of the convolution loop includes a progression of the convolution operation to generate an output feature by the parallel MAC cores and a selection loop of input and output features for performing these calculations. The convolution operation to generate output features by parallel MAC cores is performed at the innermost of the algorithm loop. And, in the selection of feature fragments to perform the convolution operation, there is a loop (M-loop) that selects the fragments of the output feature outside the convolution operation. Then, the loop (N-loop) that selects the fragments of the input feature is located outside the loop (M-loop) that selects the fragments of the output feature. Then, loops (C-loop, R-loop) that select the rows and columns of the output feature are then placed outside the loop (M-loop) that sequentially selects the output feature fragments. As a result, the reuse ratio of the input buffer 210 may be improved in the convolution operation of FIG. 8 compared to the convolution operation of FIG. 7.

According to embodiments of the inventive concept, the total operation calculation amount may be reduced in the maximum possible calculation throughput (or computation roof), which implements the compressed neural network model as a hardware platform. Then, when considering the sparse property of the sparse weights in each of the fragments of input and output features, the number of calculation cycles consumed in one layer may be greatly reduced. According to such a feature, it is possible to determine design parameters to reduce overall operation time and reduce power consumption on hardware platforms without degrading performance.

In the hardware implementation of the neural network model according to the inventive concept, the number of memory accesses may be reduced in consideration of data reuse, neural network compression, and sparse weight kernel. Then, the hardware parameters may be determined considering the environment in which data necessary for a calculation is compressed and stored in a memory.

Although the exemplary embodiments of the inventive concept have been described, it is understood that the inventive concept should not be limited to these exemplary embodiments but various changes and modifications can be made by one ordinary skilled in the art within the spirit and scope of the inventive concept as hereinafter claimed.

What is claimed is:

1. A design method of a compressed neural network system, the method comprising:
generating a compressed neural network based on an original neural network model;
analyzing a sparse weight among kernel parameters of the compressed neural network;
calculating a maximum possible calculation throughput on a target hardware platform according to a sparse property of the sparse weight;
calculating a calculation throughput with respect to access to an external memory on the target hardware platform according to the sparse property; and
determining a design parameter on the target hardware platform by referring the maximum possible calculation throughput and the calculation throughput with respect to access.

2. The method of claim 1, wherein the compressed neural network is generated by applying parameter drop-out, weight sharing, and parameter quantization techniques to the original neural network model.

3. The method of claim 1, wherein the calculating of the maximum possible calculation throughput on the target hardware platform according to the sparse property of the sparse weight comprises calculating a maximum possible calculation throughput in a specific convolution layer according to the sparse property.

4. The method of claim 1, wherein the calculating of the calculation throughput with respect to memory access on the target hardware platform according to the sparse property comprises performing a calculation by adjusting a loop method of a convolution operation.

5. The method of claim 4, wherein the loop method of the convolution operation is changed according to a direction in which a channel direction of an input feature or an output feature is shifted or a direction in which a width and height of the input feature or the output feature are shifted.

6. The method of claim 1, further comprising receiving and analyzing a resource of the target hardware platform.

7. The method of claim 6, wherein the target hardware platform comprises a Graphic Processing Unit (GPU) or a Field Programmable Gate Array (FPGA).

8. The method of claim 1, wherein the design parameter comprises at least one of an input/output buffer, a kernel buffer, a size of an input/output fragment, a calculation throughput, and operation times of the target hardware platform.

9. The method of claim 1, wherein the calculating of the maximum possible calculation throughput on the target hardware platform according to the sparse property of the sparse weight comprises calculating a maximum possible calculation throughput for each layer of the compressed neural network.

10. The method of claim 9, wherein the calculating of the calculation throughput with respect to access to the external memory on the target hardware platform comprises calculating a calculation throughput with respect to memory access for each layer of the compressed neural network.

11. The method of claim 1, further comprising determining a maximum operating point corresponding to a resource of the target hardware platform.

12. A compressed neural network system comprising:
an input buffer configured to receive an input feature from an external memory and buffer the received input feature;
a weight kernel buffer configured to receive a kernel weight from the external memory;
a multiplication-accumulation (MAC) calculation unit configured to perform a convolution operation by using fragments of the input feature provided from the input buffer and a sparse weight provided from the weight kernel buffer; and
an output buffer configured to store a result of the convolution operation in an output feature unit and deliver the stored result to the external memory,
wherein sizes of the input buffer, the output buffer, the fragments of the input feature, and a calculation throughput and a calculation cycle of the MAC calculation unit are determined according to a sparse property of the sparse weight.
